(19) United States
(12) Patent Application Publication
(10) Pub. No.: US 2011/0011945 A1
(43) Pub. Date: Jan. 20, 2011

(54) System and method for removing carbon dioxide from an atmosphere and global thermostat using the same

(76) Inventors: Peter Eisenberger, Princeton, NJ (US); Graciela Chichilnisky, New York, NY (US)

Correspondence Address: Barry G Magidoff, Esq., Paul J. Sutton, Esq.;Sutton Magidoff LLP, 909 Third Avenue - 27 FL, New York, NY, 10022, US

(21) Appl. No.: 12/819,737

(22) Filed: Jun. 21, 2010

Related U.S. Application Data
(63) Continuation of application No. 11/825,468, filed on Jul. 6, 2007, now abandoned.
Application No. 11/825,468 is a continuation-in-part of application No. 11/805,477, filed on May 22, 2007, now abandoned.
Application No. 11/805,477 is a continuation-in-part of application No. 11/805,271, filed on May 21, 2007, now abandoned.

(51) Int. Cl. A01G 15/00; B01D 53/62; C01B 31/20

(52) U.S. Cl. 239/14.1; 423/437.1

(57) ABSTRACT

A system for removing carbon dioxide from an atmosphere to reduce global warming including an air extraction system that collects carbon dioxide from the atmosphere through a medium and removes carbon dioxide from the medium; a sequestration system that isolates the removed carbon dioxide to a location for at least one of storage and generation of a renewable carbon fuel; and one or more power supplying units that supply heat to the air extraction system to remove the carbon dioxide from the medium, at least one of the one or more power supplying units being a fossil fuel plant.

### RELATED APPLICATIONS

This application is a continuation-in-part of U.S. patent application Ser. No. 11/805,477 (attorney docket no. 91904/4), filed on May 22, 2007, which in turn is a continuation-in-part of U.S. patent application Ser. No. 11/805,271 (attorney docket no. 91904/3), filed on May 21, 2007, both of which are entitled System and Method For Removing Carbon Dioxide From An Atmosphere and Global Thermostat Using The Same, the contents of which are incorporated herein by reference.

### FIELD OF THE INVENTION

The present invention relates to systems and methods for removing greenhouse gases from an atmosphere, and in particular to systems and methods for removing carbon dioxide from an atmosphere.

### BACKGROUND OF THE INVENTION

There is much attention currently focused on trying to achieve three energy related and somewhat conflicting energy related objectives: 1) provide affordable energy for economic development; 2) achieve energy security; and 3) avoid the destructive climate change caused by global warming. Many different approaches are being considered to address climate change, including increasing the use of clean, non polluting renewable energy sources such as biofuels, solar, wind and nuclear, attempting to capture and sequester the carbon dioxide emissions from fossil fuel plants, as well as increased conservation efforts. Some of these approaches, such as solar power, have had their large scale implementation blocked due to their current high costs as compared to the cost of fossil based electricity, and other approaches, such as nuclear, are restrained by their environmental and security risks. In fact, the infrastructure and supply for renewable energy is so underdeveloped (e.g., only about 0.01% of our energy is provided by solar) that there is no feasible way to avoid using fossil fuels during the rest of this century if we are to have the energy needed for economic prosperity and avoid energy shortfalls that could lead to conflict.

The climate change threat caused by global warming and the more general recognition of our need to use renewable resources that do not harm our planet has grown steadily since the first Earth Day in 1972. It is mostly undisputed that an increase in the amount of so-called greenhouse gases like carbon dioxide (methane and water vapor are the other major greenhouse gases) will increase the temperature of the planet. These greenhouse gases help reduce the amount of heat that escapes from our planet into the atmosphere. The higher the concentrations of greenhouse gases in the atmosphere the warmer the planet will be. There are complicated feedbacks that cause the amount of carbon dioxide and other greenhouse gases to change naturally even in the absence of human impact. Climate change throughout geological history has caused many extinctions. The concern about the threat of human induced climate change (i.e., global warming) resulted in the Kyoto Protocol that has been approved by over 165 countries and is an international agreement that commits the developed countries to reduce their carbon emissions.

One reason global warming is thought by the Intergovernmental Panel on Climate Change (IPCC) to be a threat is because of the sea level rise resulting from the melting of glaciers and the expansion of the ocean as our planet becomes hotter. Hundreds of millions of people who live just above sea level on islands or on the coasts are threatened by destructive flooding requiring relocation or the building of sea walls if the sea level rises even a meter. There is also a threat to other species from climate change which will destroy ecosystems that cannot adjust to the fast rate of human caused climate change. Additional threats include increased infectious diseases and more extreme weather as well as direct threats from extreme heat.

The challenge of dealing with global warming can be demonstrated by using a simple model. Let C_{CA} (Y_{N}) represent the carbon dioxide added to the atmosphere in year Y_{N} in gigatonnes per year. Similarly, let C_{EX} (Y_{N}) equal the amount extracted, C_{EM} (Y_{N}) the amount emitted by humans and C_{N} (Y_{N}) be the amount either added or removed due to natural variations in the carbon cycle. Today, the land stores each year approximately 1.8 gigatonnes(10⁹ tonnes) of carbon dioxide and the ocean approximately 10.5 gigatonnes (note carbon dioxide is 3.66 times heavier than carbon), while the amount humans add by emissions is about 24 gigatonnes of carbon dioxide. More generally, we have:

C_{CA}(Y_{N})=C_{EX}(Y_{N})+C_{EM}(Y_{N})+C_{N}(Y_{N}) (1)

C_{A}(Y_{N+1})=C_{A}(Y_{N})+C_{CA}(Y_{N}) (2)

where C_{A}(Y_{N}) is the amount of carbon in the atmosphere in year Y_{N}, 2780 gigatonnes of carbon dioxide today. Other forms of carbon contribute to global warming, most notably methane, although by weight they represent a small component

If C_{EX} (Y_{N}) is set to zero than the only way one could possibly stop adding carbon dioxide to the atmosphere would be to reduce our emissions to be equal to the natural uptake. However, C_{N} (Y_{N}) itself varies greatly and can be a net addition to the atmosphere from the much larger natural carbon cycle which adds and subtracts carbon at about 750 gigatonnes of carbon per year. It is the shifts in this natural balance that has caused climate change before our species existed and will also continue to do so in the future. Thus, it is clear that there is no solution that only reduces human contributions to carbon dioxide emissions that can remove the risk of climate change. With air extraction and the capability to increase or decrease the amount of carbon dioxide in the atmosphere one can in principle compensate for other greenhouse gases like methane that can change their concentrations and cause climate change.

Further, although there are known processes for removing some of the carbon dioxide from the flue gas of a fossil fuel plant, such processes are internal to the fossil fuel plant itself, so that there is no effect on the reduction of carbon dioxide already present in the atmosphere.

Accordingly, there is a broadly recognized need for a system and method for reducing the amount of carbon dioxide in the atmosphere created by burning of fossil fuels and for providing a low cost, non-polluting renewable energy source as a substitute for fossil fuels.

### SUMMARY OF THE INVENTION

A system for removing carbon dioxide from an atmosphere to reduce global warming according to an exemplary embodiment of the present invention comprises: an air extraction system that collects carbon dioxide from the atmosphere through a medium and removes carbon dioxide from the medium; a sequestration system that isolates the removed carbon dioxide to a location for at least one of storage and generation of a renewable carbon fuel; and one or more power supplying units that supply heat to the air extraction system to remove the carbon dioxide from the medium, at least one of the one or more power supplying units being a fossil fuel plant.

In at least one embodiment, the air extraction system comprises an air contactor that includes the medium to absorb carbon dioxide from the atmosphere.

In at least one embodiment, the air contactor is selected from the group of air contactors consisting of: convection towers, absorption pools and packed scrubbing towers.

In at least one embodiment, the medium is selected from the group of mediums consisting of: a liquid, a porous solid, a gas and mixtures thereof.

In at least one embodiment, the medium is an NaOH solution.

In at least one embodiment, the medium comprises an amine.

In at least one embodiment, the air extraction system collects carbon dioxide and the sequestration system isolates the removed carbon dioxide using the heat supplied by the one or more power supplying units.

In at least one embodiment, the location of the isolated carbon dioxide is underground.

In at least one embodiment, the location is at a remote site upwind from one or more other components of the system.

A method for removing carbon dioxide from an atmosphere to reduce global warming according to an exemplary embodiment of the present invention comprises the steps of: collecting air from the atmosphere; removing carbon dioxide from the collected air; and isolating the removed carbon dioxide to a location for at least one of storage and generation of a renewable carbon fuel, wherein at least one of the collecting, removing and isolating steps is performed using process heat generated by a fossil fuel plant.

A global thermostat for controlling average temperature of a planet's atmosphere according to an exemplary embodiment of the present invention comprises: one or more first systems for extracting greenhouse gases from the atmosphere at a rate slower than the greenhouse gases are increasing in the atmosphere and at least one of storing the greenhouse gases and generating a renewable carbon fuel using the greenhouse gases; one or more second systems for extracting greenhouse gases from the atmosphere at a rate faster than the greenhouse gases are increasing in the atmosphere and at least one of storing the greenhouse gases and generating a renewable carbon fuel using the greenhouse gases; one or more third systems for extracting greenhouse gases from the atmosphere at the same rate as the greenhouse gases are increasing or decreasing in the atmosphere and at least one of storing the greenhouse gases and generating a renewable carbon fuel using the greenhouse gases; and a fossil fuel plant for providing heat to at least one of the first, second and third systems.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a generalized block diagram of a system for removing carbon dioxide from an atmosphere according to an exemplary embodiment of the present invention;

FIG. 2 is a block diagram of a system for removing carbon dioxide from an atmosphere according to an exemplary embodiment of the present invention;

FIG. 3 is a block diagram of an air extraction system according to an exemplary embodiment of the present invention; and

FIG. 4 is a map illustrating a global thermostat according to an exemplary embodiment of the present invention;

### DETAILED DESCRIPTION OF PREFERRED EMBODIMENTS

FIG. 1 is a generalized block diagram of a system, generally designated by reference number 1, for removing carbon dioxide from an atmosphere according to an exemplary embodiment of the present invention. The system 1 includes an air extraction system 40 and a sequestration system 50. The air extraction system 40 preferably incorporates any known or later-discovered CO₂ extraction method, including methods which use a medium to absorb and/or bind CO₂ from the atmospheric air by exposing the medium to chemical, electrical and/or physical interaction with the CO₂ in the captured air. The medium may be liquid, gaseous or solid, or a combination of liquid, gaseous and solid substances, where in the case of solids, the substance is preferably porous. The medium is preferably recyclable so that after the CO₂ is captured by the medium and separated from the medium for sequestration, the medium can be reused for absorption/binding of additional CO₂. However, in other embodiments the medium may be sequestered along with the captured CO₂. As shown in FIG. 1, the separation of the CO₂ from the medium, as well as other processes such as the absorption/binding of CO₂ and the sequestration of the CO₂ performed by the sequestration system 50, may be made more efficient by the addition of heat to the air extraction system 40. In the present invention, the heat is process heat generated by a fossil fuel power plant, to be described in further detail below. The term “process heat” as used herein refers to the lower temperature heat remaining after the higher temperature heat has been used to generate electricity. More generally, the term “process heat” refers to any low temperature heat remaining after a primary process or that is added by the process itself, such as, for example, exothermic carbonation reactions in which carbon dioxide is stored as a mineral.

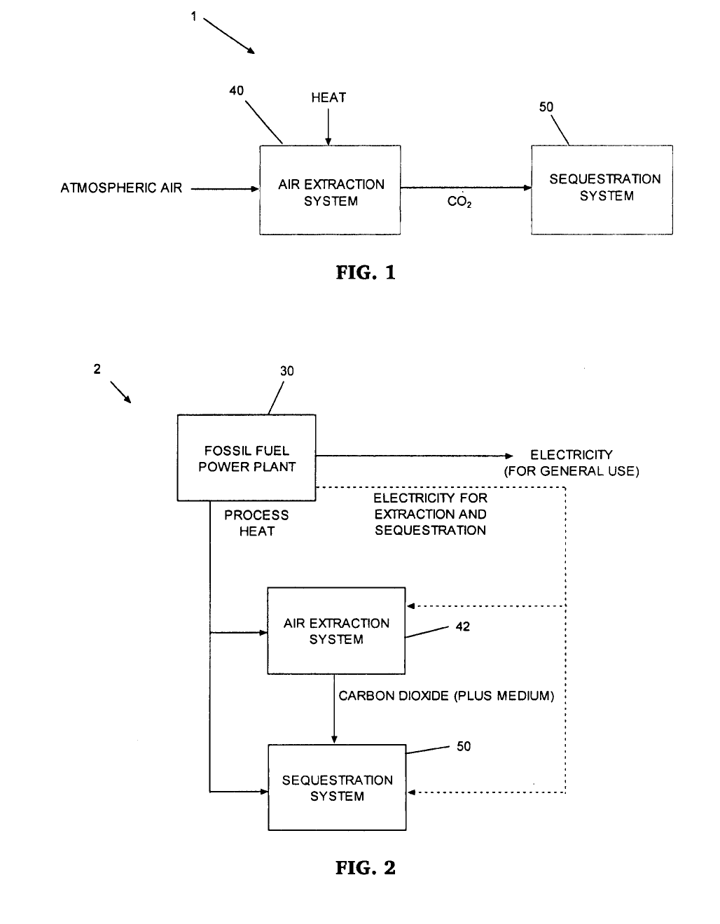

FIG. 2 is a block diagram of a system, generally designated by reference number 2, for removing carbon dioxide from an atmosphere according to an exemplary embodiment of the present invention. The system 2 includes a fossil fuel power plant 30, an air extraction system 42 and a sequestration system 50. Each of these components of the system 2 are explained in detail below.

The fossil fuel power plant 30 may be any known or later discovered facility that relies on the burning of fossil fuels, such as, for example, coal, fuel oil, natural gas and oil shale, for the generation of electricity. The thermal energy produced by the fossil fuel power plant 30 is used to produce electricity and the residual thermal energy (i.e., process heat) may be used to drive the air extraction system 42 and/or the sequestration system 50. For example, the process heat from the fossil fuel power plant 30 may be used to improve the efficiency of chemical and/or physical reactions used in the air extraction system 42 to absorb CO₂ from the air and/or to drive off the CO₂ from the medium.

The residual heat provided by the fossil fuel power plant 30 may be supplemented by energy generated by a supplemental energy source. For example, the supplemental energy source may be a waste incineration plant or a renewable energy source, such as, for example, solar, nuclear, biomass, and geothermal energy sources, which provides additional thermal energy to drive the air extraction system 42 and/or the sequestration system 50. Process heat from the supplemental energy source may also be used to drive the air extraction system 42 and/or the sequestration system 50.

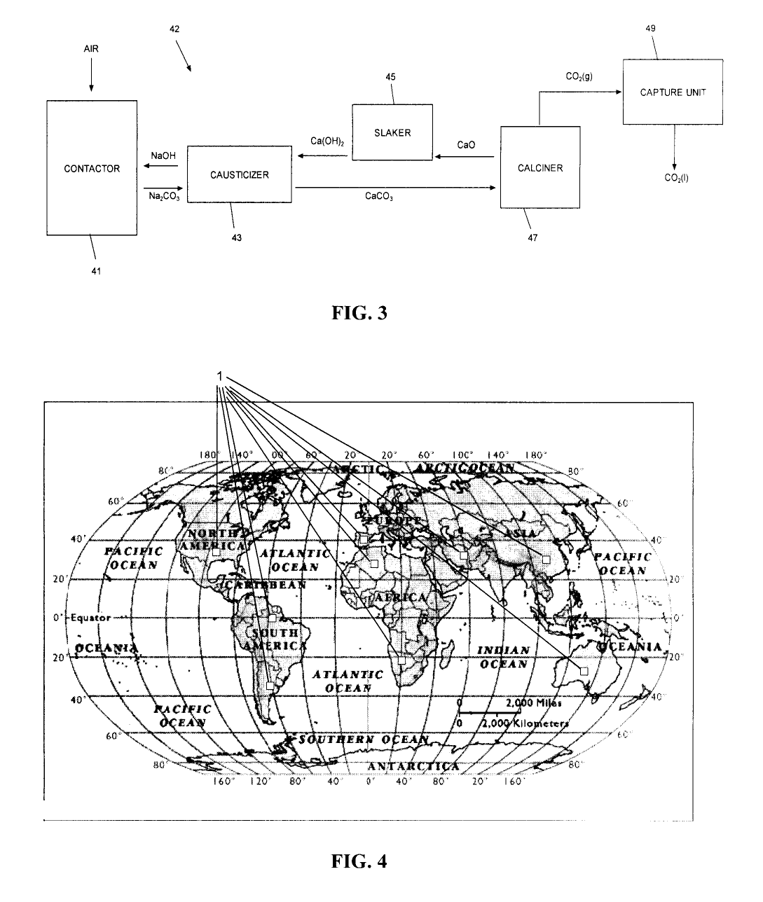

FIG. 3 is a block diagram of the air extractor system 42 useable with the system 2 according to an exemplary embodiment of the present invention. The air extractor system 42 includes an air contactor 41, a causticizer 43, a slaker 45, a calciner 47 and a capture unit 49. The air contactor 41 may use a sorbent material to selectively capture CO₂ from the air, and may be composed of any known or later-discovered contactor structures, such as, for example, large convection towers, open, stagnant pools, and packed scrubbing towers. In the present embodiment, the sorbent material may be sodium hydroxide (NaOH), which readily absorbs CO₂ from the air. It should be appreciated that other known or future-discovered capture methods may be used, such as, for example, chemical absorption, physical and chemical adsorption, low-temperature distillation, gas-separation membranes, mineralization/biomineralization and vegetation. As a further example, as known in the art, aqueous amine solutions or amine enriched solid sorbents may be used to absorb CO₂. Preferably, the sorbent material is regenerated and the capture method requires less than about 100-120° C. heat to regenerate the sorbent material.

In this embodiment, at the air contactor 41, CO₂ may be absorbed into an NaOH solution forming sodium carbonate (Na₂CO₃). Of course, other known or future-developed absorbers may also be used as an alternative or in addition to an NaOH solution. The generated Na₂CO₃ is then sent to the causticizer 43, where the NaOH is regenerated by addition of lime (CaO) in a batch process. The resulting CaCO₃ solid is sent to the calciner 47 where it is heated in a kiln to regenerate the CaO, driving off the CO₂ in a process known as calcination. The regenerated CaO is then sent through the slaker 45, which produces slaked lime Ca(OH)₂ for use in the causticizer 43.

The capture unit 49 captures the CO₂ driven off at the calciner 47 using any know or later-discovered CO₂ capturing method that is effective in the low concentrations in which CO₂ is present in the atmosphere and that needs only low temperature heat for regeneration. For example, the capture unit 49 may use an amine based capture system, such as the system described in U.S. Pat. No. 6,547,854, incorporated herein by reference. The capture unit 49 may also compress the captured CO₂ to liquid form so that the CO₂ may be more easily sequestered.

The sequestration system 50 may use any known or future-discovered carbon storing technique, such as, for example, injection into geologic formations or mineral sequestration. In the case of injection, the captured CO₂ may be sequestered in geologic formations such as, for example, oil and gas reservoirs, unmineable coal seams and deep saline reservoirs. In this regard, in many cases, injection of CO₂ into a geologic formation may enhance the recovery of hydrocarbons, providing the value-added byproducts that can offset the cost of CO₂ capture and sequestration. For example, injection of CO₂ into an oil or natural gas reservoir pushes out the product in a process known as enhanced oil recovery. The captured CO₂ may be sequestered underground, and according to at least one embodiment of the invention at a remote site upwind from the other components of the system 2 so that any leakage from the site is re-captured by the system 2.

In regards to mineral sequestration, CO₂ may be sequestered by a carbonation reaction with calcium and magnesium silicates, which occur naturally as mineral deposits. For example, as shown in reactions (1) and (2) below, CO₂ may be reacted with forsterite and serpentine, which produces solid calcium and magnesium carbonates in an exothermic reaction.

½Mg₂SiO₄+CO₂=MgCO₃+½SiO₂+95 kJ/mole (1)

⅓Mg₃Si₂O₅(OH)₄+CO₂=MgCO₃+⅔SiO₂+⅔H₂O+64 kJ/mole (2)

Both of these reactions are favored at low temperatures. In this regard, both the air capture and air sequestration processes described herein may use electricity and/or thermal energy generated by the fossil fuel power plant 30 to drive the necessary reactions and power the appropriate system components. In an exemplary embodiment of the present invention, a high temperature carrier may be heated up to a temperature in a range of about 400° C. to about 500° C. to generate steam to run a generator for electricity, and the lower temperature steam that exits from the electrical generating turbines can be used to drive off the CO₂ and regenerate the sorbent (e.g., NaOH). The temperature of the high temperature heat, the generated electricity and the temperature of the lower temperature process heat remaining after electricity production can be adjusted to produce the mix of electricity production and CO₂ removal that is considered optimal for a given application. In addition, in exemplary embodiments, still lower temperature process heat that emerges out of the capture and sequestration steps may be used to cool equipment used in these steps.

One or more systems for removing carbon dioxide from an atmosphere may be used as part of a global thermostat according to an exemplary embodiment of the present invention. By regulating the amount of carbon dioxide in the atmosphere and hence the greenhouse effect caused by carbon dioxide and other gas emissions, the system described herein may be used to alter the global average temperature. According to at least one exemplary embodiment of the present invention, several carbon dioxide capture and sequestration systems may be located at different locations across the globe so that operation of the multiple systems may be used to alter the CO₂ concentration in the atmosphere and thus change the greenhouse gas heating of the planet. Locations may be chosen so as to have the most effect on areas such as large industrial centers and highly populated cities, or natural point sources of CO₂ each of which could create locally higher concentrations of CO₂ that would enable more cost efficient capture. For example, as shown in FIG. 4, multiple systems 1 may be scattered across the globe, and international cooperation, including, for example, international funding and agreements, may be used to regulate the construction and control of the systems 1. In this regard, greenhouse gases concentration can be changed to alter the average global temperature of the planet to avoid cooling and warming periods, which can be destructive to human and ecological systems. During the past history of our planet, for example, there have been many periods of glaciation and rapid temperature swings that have caused destruction and even mass extinctions. Such temperature swings in the future could be a direct cause of massive damage and destabilization of human society from conflicts resulting from potential diminished resources. The global thermostat described herein may be the key to preventing such disasters in the decades to come.

Preferably, the air extraction system 42 and the sequestration system 50 are located at a facility that is separate from the fossil fuel power plant 30. Thus, the overall system 2 functions to remove from the atmosphere carbon dioxide produced by sources other than the fossil fuel power plant 30. It should also be appreciated that in an embodiment of the invention, the air extraction system 42 and the sequestration system 50 may be used to remove the equivalent amount of CO₂ generated by the fossil fuel power plant, so that the entire facility may be considered “carbon neutral”. Also, removing CO2 from the atmosphere, rather than directly from the flue gases, is advantageous in that it avoids the pollutants in the flue gases that would poison the adsorbent and otherwise negatively effect costs and operations.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A system for removing carbon dioxide from an atmosphere to reduce global warming and increase availability of renewable energy, comprising:
an air extraction system that collects carbon dioxide from the atmosphere through a medium and removes carbon dioxide from the medium;
a sequestration system that isolates the removed carbon dioxide to a location for at least one of storage and generation of a renewable carbon fuel; and
one or more power supplying units that supply heat to the air extraction system to remove the carbon dioxide from the medium, at least one of the one or more power supplying units being a fossil fuel plant;
wherein the air extraction system collects carbon dioxide and the sequestration system isolates the removed carbon dioxide using the heat supplied by the one or more power supplying units.

2. The system of claim 25, wherein the air extraction system comprises an air contactor that includes the medium to absorb carbon dioxide from the atmosphere.

3. The system of claim 2, wherein the air contactor is selected from the group of air contactors consisting of: convection towers, absorption pools and packed scrubbing towers.

4. The system of claim 2, wherein the medium is selected from the group of mediums consisting of: a liquid, a porous solid, a gas and mixtures thereof.

5. The system of claim 4, wherein the medium is an NaOH solution.

6. The system of claim 4, wherein the medium comprises an amine.

7. The system of claim 25, wherein the air extraction system collects carbon dioxide and the sequestration system isolates the removed carbon dioxide using the heat supplied by the one or more power supplying units.

8. The system of claim 25, wherein the location of the isolated carbon dioxide is underground.

9. The system of claim 25, wherein the location is at a remote site upwind from one or more other components of the system.

10. A method for removing carbon dioxide from an atmosphere to reduce global warming and increase availability of renewable energy, comprising:
collecting air from the atmosphere;
removing carbon dioxide from the collected air;
isolating the removed carbon dioxide to a location for at least one of storage and generation of a renewable carbon fuel,
wherein at least one of the collecting, removing and isolating steps is performed using process heat generated by a fossil fuel plant.

11. The method of claim 10, wherein the step of removing comprises absorbing the carbon dioxide using an absorber.

12. The method of claim 11, wherein the absorber is an NaOH solution.

13. The method of claim 11, wherein the absorber comprises an amine.

14. The method of claim 11, wherein the step of isolating comprises at least one of mineral sequestration and injection into geologic formations.

15. A global thermostat for controlling average temperature of a planet's atmosphere, comprising:
one or more first systems for extracting greenhouse gases from the atmosphere at a rate slower than the greenhouse gases are increasing in the atmosphere and at least one of storing the greenhouse gases and generating a renewable carbon fuel using the greenhouse gases;
one or more second systems for extracting greenhouse gases from the atmosphere at a rate faster than the greenhouse gases are increasing in the atmosphere and at least one of storing the greenhouse gases and generating a renewable carbon fuel using the greenhouse gases;
one or more third systems for extracting greenhouse gases from the atmosphere at the same rate as the greenhouse gases are increasing or decreasing in the atmosphere and at least one of storing the greenhouse gases and generating a renewable carbon fuel using the greenhouse gases; and
a fossil fuel plant for providing heat to at least one of the first, second and third systems.

16. The global thermostat of claim 15, wherein the greenhouse gases comprises carbon dioxide, and the at least one of the first, second and third systems comprises:
an air extraction system that collects carbon dioxide from the atmosphere through a medium and removes carbon dioxide from the medium; and
a sequestration system that isolates the removed carbon dioxide to a location for at least one of storage and generation of a renewable carbon fuel,
wherein the heat provided by the fossil fuel plant is used by the air extraction system to remove the carbon dioxide from the medium.

17. The system of claim 16, wherein the air extraction system comprises an air contactor that includes the medium to absorb carbon dioxide from the atmosphere.

18. The system of claim 17, wherein the air contactor is selected from the group of air contactors consisting of: convection towers, absorption pools and packed scrubbing towers.

19. The system of claim 16, wherein the medium is selected from the group of mediums consisting of: a liquid, a porous solid, a gas and mixtures thereof.

20. The system of claim 16, wherein the medium is an NaOH solution.

21. The system of claim 16, wherein the medium comprises an amine.

22. The system of claim 16, wherein the air extraction system collects carbon dioxide and the sequestration system isolates the removed carbon dioxide using the heat supplied by the fossil fuel plant.

23. The system of claim 16 wherein the location is underground.

24. The system of claim 16 wherein the location is at a remote site upwind from one or more other components of the system.

25. The system of claim 1, wherein the air extraction system comprises a source of process heat for removing carbon dioxide from the medium.
